(19) United States
(12) Patent Application Publication
(10) Pub. No.: US 2004/0234105 A1
(43) Pub. Date: Nov. 25, 2004

(54) Method of automatic vehicle licence plate recognition by color discrimination and reorganization

(76) Inventors: Quen-Zong Wu, Taoyuan (TW); Heng-Sung Liu, Taoyuan (TW); Jun-Wen Chen, Taoyuan (TW)

Correspondence Address: RABIN & BERDO, P.C., Suite 500, 1101 14th Street, Washington, DC, 20005, US

(21) Appl. No.: 10/440,092

(22) Filed: May 19, 2003

(51) Int. Cl. G06K 9/00

(52) U.S. Cl. 382/105

(57) ABSTRACT

An innovative method of automatic vehicle licence plate recognition is described, the vehicle licence plate recognition procedure is carried out respectively with reference to three component color red(R), green(G), and blue(B) grey level pixel maps, and then the results are reorganized. Sine the synthesized three component color R, G, B grey level pixel map is obtained by mixing R, G, B color component according to a definite proportion (for example dividing the sum of three component by 3), hence among the three component color grey level pixel maps, there must be at least one (R, or G, or B) whose contrast is better than that of the synthesized one. This most confidential one is picked out as the final result of the licence plate recognition.

### BACKGROUND OF THE INVENTION

1. Field of the Invention

The present invention relates to method of automatic vehicle licence plate identification by color discrimination and reorganization, and more particularly, to a method of automatic vehicle licence plate identification in which the grey level pixel maps of red, green and blue colored vehicle's images are discriminated and identified automatically with respect to the vehicle licence plate, and the results are reorganized for checking their correctness.

2. Description of the Prior Art

In the conventional method of vehicle number identification, the combined result of respective three component color, i.e. red(R), green(G), and blue(B) grey level pixel maps are transformed into a synthetic grey level pixel map for identification. However, such an identification method is hard to achieve a precise result.

Aiming at the above depicted fact, the present invention is to propose a newly developed method of automatic vehicle number identification by color discrimination and reorganization which is produced by an innovative idea of the inventor's long time research and simulation.

### SUMMARY OF THE INVENTION

The object of the present invention is to provide a method of automatic license plate identification by color discrimination and reorganization in which the respective grey level pixel maps of red(R), green(G), and blue(B) colored vehicle's images are discriminated and then identified automatically with respect to the licence plate, and then the results are reorganized for evaluating the correctness. Meanwhile, among three grey level pixel maps of R, G and B colored images, there must be at least one whose identified result is judged to be most close to the correctness. The identified results of three respective component colored R, G and B grey level pixel maps may be calibrated and reorganized according to various colored licence plate coding rules as knowledge since different licence plate colors correspond to their respective licence plate coding rules.

To achieve the aforementioned object, the automatic vehicle licence plate identification is carried out respectively with reference to three component colored R, G, and B grey level pixel maps, and then the identified results are reorganized. Supposing the identified result of R component grey level pixel map is represented by SR, that of G component grey level pixel map is represented by SG, and that of B component grey level pixel map is represented by SB, the coding rule of the vehicle licence plate whose base color or letter color has a R component reaching above a preset threshold is represented by CR, the coding rule of the vehicle number whose base color or letter color has a G component reaching above a preset threshold level is represented by CG, and the coding rule of the vehicle number whose base color or letter color has a B component reaching above a preset threshold is represented by CB. An adjusted value SR′ is obtained after evaluating the confidence level of SR within the range of CR, an adjusted value SG′ is obtained after evaluating the confidence level of SG within the range of CG, and an adjusted value SB′ is obtained after evaluating the confidence level of SB within the range of CB. The resultant vehicle licence plate may be selected among the values SR′, SG′ and SB′ the one which is the most confidential.

### BRIEF DESCRIPTION OF THE DRAWINGS

FIG. 1 is the flow chart of the method of automatic licence plate number identification by color discrimination and reorganization according to the present invention.

### DETAILED DESCRIPTION OF THE PREFERRED EMBODIMENT

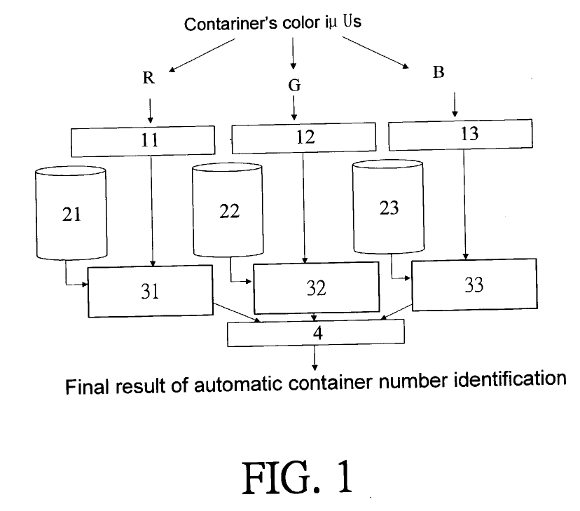

Referring to FIG. 1, it can be seen from the flow chart of the present invention that the component units involved in the present invention comprises: a module for automatically recognizing the licence plates in the gray-level pixel maps of red-component images 11, a module for automatically recognizing the licence plates in the gray-level pixel maps of green-component images 12, a module for automatically recognizing the licence plates in the gray-level pixel maps of blue-component images 13, a library of coding rules for the licence plates of red components denser than a pre-set threshold 21, a library of coding rules for the licence plates of green components denser than a pre-set threshold 22, a library of coding rules for the licence plates of blue components denser than a pre-set threshold 23, a module for adjusting precognition results and evaluating confidence levels of licence plates in the gray-level pixel maps of red-component images 31, a module for adjusting recognition results and evaluating confidence levels of licence plates in the gray-level pixel maps of green-component images 32, a module for adjusting recognition results and evaluating confidence levels of licence plates in the gray-level pixel maps of blue-component images 33, and a comparator 4. The coding rule library 21 accommodates an coding rule of the base color or a letter color whose degree of R component is higher than other ones above a threshold value (for example, in the order red, purple, orange, white). The coding rule library 22 accommodates an coding rule of the base color or a letter color whose degree of G component is higher than other ones above a threshold value (for example, in the order green, white). The coding rule library 23 accommodates an coding rule of the base color or a letter color whose degree of B component is higher than other ones above a threshold value (for example, in the order blue, purple, white). The modules 11, 12, and 13 automatically recognize vehicle licence number in respective grey level pixel maps of R, G and B component images. The three recognized results are inputted respectively into the modules 31, 32 and 33 for adjusting results of recognized vehicle licence plate and evaluating correctness thereof according to coding rules stored into the coding rule libraries 21, 22 and 23. The degree of confidence of the three data obtained as such is further inputted into the comparator 4 for final evaluation so as to pick out a final recognition result which is the most confidential one.

The method of automatic vehicle licence plate recognition by color discrimination and reorganization comprises the steps:

Step 1: discriminating the color of a vehicle licence plate's image into red (R), green (G), and blue (B) grey level pixel maps respectively;

Step 2: inputting the R, G and B grey level pixel maps into the R, G, and B modules 11, 12, and 13 respectively for carrying out recognition;

Step 3: inputting the three recognized results obtained in step 2 respectively into the modules 31, 32, and 33 for adjusting the recognized results against R, G, and B component grey level pixel maps and evaluating individual correctness according to the coding rules of the coding rule libraries 21, 22 and 23;

Step 4: inputting the adjusted recognition results and evaluated degree of correctness obtained in step 3 into the comparator 4; and

Step 5: carrying out the final comparison and evaluation for the data inputted from step 4 so as to pick out a final recognized result which is most confidential.

In the above step 2, the R, G, and B grey level pixel maps can be inputted into one of the automatic vehicle licence plate recognition modules 11, 12 or 13 for recognizing and making final judgment.

In the above step 3, the three identified results can be adjusted and their result can be evaluated in one of the adjusting modules 31, 32, or 33 according to the coding rules of the three encoding rule libraries 21, 22, or 23.

From the above description, it can be seen that the method of automatic vehicle licence plate recognition by color discrimination and reorganization has several noteworthy advantages i.e. the respective grey level pixel maps of R, G and B colored vehicle's licence images are discriminated and then recognized automatically and according to various color coding rules as knowledge. The final result obtained by this method is far more precise than the result obtained by the conventional method in which the combined result of respective three R, G and B component color grey level pixel maps is transformed into a synthetic grey level pixel map for identification.

Those who are skilled in the art will readily perceive how to modify the invention. Therefore, the appended claims are to be construed to cover all equivalent structures which fall within the true scope and spirit of the invention.

What is claimed is:

1. Method of automatic vehicle licence plate recognition by color discrimination and reorganization comprising the steps;
Step 1: discriminating the color of a vehicle number's image into red(R), green(G), and blue(B) grey level pixel maps respectively;
Step 2: inputting said R, G, and B grey level pixel maps into three R, G, and B vehicle licence plate recognition modules respectively so as to carry out recognition;
Step 3: inputting the three recognized results obtained in step 2 respectively into three modules for adjusting the recognized results against R, G, and B component grey level pixel maps and evaluating individual correctness according to coding rules stored in three vehicle licence plate coding rule libraries of R, G, and B color;
Step 4: inputting the adjusted recognition results and evaluated degree of reality obtained in step3 into a comparator; and
Step 5: carrying out the final comparison and evaluation for said data inputted from step 4 so as to pick out a final recognized result which is most confidential:

2. The method as in claim 1, wherein said R, G and B grey level pixel maps are inputted into one of said automatic vehicle licence plate recognition modules for recognizing and making final judgment.

3. The method as in claim 1, wherein said three recognized results are adjusted and their correctness is evaluated in one of said adjusting modules according to said coding rules stored in said three coding rule libraries.
